(19) United States
(12) Patent Application Publication
(10) Pub. No.: US 2012/0229093 A1
(43) Pub. Date: Sep. 13, 2012

(54) ELECTRICAL CHARGE AND DISCHARGE SYSTEM, METHOD OF CONTROLLING ELECTRICAL CHARGE AND DISCHARGE OF A BATTERY, AND COMPUTER-READABLE RECORDING MEDIUM

(75) Inventor: Souichi SAKAI, Moriguchi-shi (JP)

(73) Assignee: SANYO Electric Co., Ltd., Moriguchi-shi (JP)

(21) Appl. No.: 13/425,106

(22) Filed: Mar. 20, 2012

Related U.S. Application Data
(63) Continuation of application No. PCT/JP2011/050933, filed on Jan. 20, 2011.

(30) Foreign Application Priority Data
Jan. 20, 2010 (JP) 2010-010307

(51) Int. Cl. H02J 7/00

(52) U.S. Cl. 320/134

(57) ABSTRACT

This electrical charge and discharge system comprises a battery configured to store electric power generated by a power generator using renewable energy, a power output device configured to output power generated by the power generator and power discharged by the battery and a controller configured to control charge and discharge of the battery and to terminate the charge and discharge control of the battery when determined that a fluctuation in power generated by the power generator is less than a standard in continuity for not less than a first period.

### CROSS REFERENCE TO RELATED APPLICATIONS

This application is a continuation of International Application No. PCT/JP2011/050933, filed Jan. 20, 2011, which claims priority from Japanese Patent Application No. 2010-010307 filed Jan. 20, 2010, the entire contents of which are incorporated herein by reference.

### FIELD OF INDUSTRIAL USE

The present invention relates to an electrical charge and discharge system, a method of controlling electrical charge and discharge of a battery, and a computer-readable recording medium, in particular, to a charge and discharge system provided with a battery capable of storing the power generated by a power generator using renewable energy, a method of controlling electrical charge and discharge of a battery, and a computer-readable recording medium.

### PRIOR ART

In recent years, the number of instances where power generators utilizing renewable energy such as wind power or sunlight are connected to consumer homes in receipt of a supply of alternating power from an electricity substation has increased. The power generated by the power generators is output to the power consuming devices in the consumer home.

These types of power generators are connected to the power grid subordinated to the substation, and power generated by the generators is output to the power consuming devices side of the consumer location. The superfluous electric power, which is not consumed by the power consuming devices in the consumer location, is output to the power grid. The flow of this power towards the power grid from the consumer location is termed “counter-current flow”, and the power output from the consumer to the electric grid is termed “counter-current power”.

In this situation the power suppliers such as the power companies and the like have a duty to ensure the stable supply of electric power and need to maintain the stability of the frequency and voltage of the overall power grid, including the counter-current power components. In this situation the power suppliers such as the power companies and the like have a duty to ensure the stable supply of electric power and need to maintain the stability of the frequency and voltage of the overall electric power grid, including the counter-current power components. For example, the power supply companies maintain the stability of the frequency of the overall electric power grid by a variety of method in correspondence with the size of the fluctuation period.

Specifically, in general, in respect of a load component with a variable period of some tens of minutes, an economic dispatching control (EDC) is performed to enable output sharing of the generated amount in the most economical manner.

This EDC is controlled based on the daily load variation expectation, and it is difficult to respond to the increases and decreases in the load fluctuation from minute to minute and second to second (the components of the fluctuation period which are less than some tens of minutes). In that instance, the power companies adjust the amount of power supplied to the power grid in correspondence with the minute fluctuations in the load, and perform plural controls in order to stabilize the frequency. Other than the EDC, these controls are called frequency controls, in particular, and the adjustments of the load variation components not enabled by the adjustments of the EDC are enabled by these frequency controls.

More specifically, for the components with a fluctuation period of less than approximately 10 seconds, their absorption is enabled naturally by means of the endogenous control functions of the power grid itself. Moreover, for the components with a fluctuation period of about 10 seconds to the order of several minutes, they can be dealt with by the governor-free operation of the generators in each generating station. Furthermore, for the components with a fluctuation period of the order of several minutes to tens of minutes, they can be dealt-with by load frequency control (LFC). In this load frequency control, the frequency control is performed by the adjustment of the generated power output of the generating station for LFC by means of a control signal from the central power supply command station of the power supplier.

However, the output of power generators utilizing renewable energy may vary abruptly in correspondence with the weather and such like. This abrupt fluctuation in the power output of this type of power generator applies a gross adverse impact on the degree of stability of the frequency of the power grid they are connected to. This adverse impact becomes more pronounced as the number of consumers with generators using renewable energy increases. As a result, in the event that the number of consumers with electricity generators utilizing renewable energy increases even further henceforth, there will be a need arising for sustenance of the stability of the power grid by the control of the abrupt variation in the output of the generators.

In relation to that, there have been proposals, conventionally, to provide power generation systems with batteries to enable the storage of electricity resulting from the power output generated by power generators, in addition to the generators utilizing renewable energy, in order to control the abrupt fluctuation in the power output of these types of generators. Such a power generation system was disclosed, for example, in Japanese laid-open patent publication No. 2001-5543.

In Japanese the laid-open published patent specification 2001-5543 described above, there is the disclosure of a power generation system provided with solar cells, inverters which are connected to both the solar cells and the power grid, and a battery which is connected to a bus being connected to the inverter and the solar cell. This power generation system, by performing the charging and discharging of the battery following the fluctuations in the power output from the solar cells, suppresses the fluctuations in the power output from the inverters. By these means, because the fluctuations in the power output to the power grid are suppressed, the suppression of adverse effects on the frequency of the power grid are enabled.

### PRIOR ART REFERENCES

### Patent References

Patent Reference #1: Japanese laid-open published patent specification 2001-5543

### OUTLINE OF THE INVENTION

### Problems to be Solved by the Invention

However, in this power generation system, because the charging and discharging of the battery following the fluctuations in the generated power of the power generator is performed on every such instance, the number of instances of charging and discharging are great, and as a result, there is the problem that the lifetime of the battery is reduced.

This invention was conceived of to resolve the type of problems described above, and one object of this invention is the provision of an electrical charge and discharge system, a method of controlling electrical charge and discharge of a battery storing electric power generated by a power generator generating electric power using renewable energy, and a computer-readable recording medium which records a control programs for causing one or more computers to perform the steps, which contrive to enable a longer lifetime for the battery while suppressing the effects on the power grid caused by the fluctuations in the output power of the power generator.

### Summary of the Invention

In order to achieve the objectives described above, the electrical charge and discharge system of the first aspect of this invention comprises a battery configured to store electric power generated by a power generator using renewable energy, a power output device configured to output power generated by the power generator and power discharged by the battery and a controller configured to control charge and discharge of the battery and to terminate the charge and discharge control of the battery when determined that a fluctuation in power generated by the power generator is less than a standard in continuity for not less than a first period.

The method of controlling electrical charge and discharge of a battery storing electric power generated by a power generator generating electric power using renewable energy of the second aspect of this invention comprises determining a fluctuation in power generated by the power generator and terminating a charge and discharge control of the battery when determined that a fluctuation in power generated by the power generator is less than a standard in continuity for not less than a first period.

### Benefits of the Invention

By means of the present invention, when the fluctuations of the power generated by the power generator is less than a specific standard, and the effects of the direct output to the power grid of the power generated by the power generator is also small, the termination of the control of charge and discharge is enabled. By this means, because the number of instances of charge and discharge of the battery can be reduced, a contrivance at lengthening the lifetime of the battery is enabled. Moreover, by making the continuity of the low fluctuation stage for a first period a condition of the termination, the termination of the charge and discharge control can be suppressed in a situation where the fluctuations become smaller for a short period followed by the fluctuations becoming greater immediately thereafter. Moreover, because the charge and discharge control is not performed in the situation where the state where the fluctuations in the power generated are small for more than the length of the first period, the fluctuations in the state of charge of the battery can be reduced by that amount. By this means, because the degree of depth of the charge and discharge of the battery can be reduced, this enables a contrivance at lengthening the lifetime of the battery.

### BRIEF EXPLANATION OF THE FIGURES

FIG. 1 is a block diagram showing the configuration of the power generation system of the first embodiment of the invention.

FIG. 2 is a drawing to explain the relationship between size of the load fluctuations of the output to the power grid, and the period of the fluctuations.

FIG. 3 is a flow chart to explain the flow of the control of the charge and discharge control of the power generation system in the first embodiment shown in FIG. 1.

FIG. 4 is a drawing to explain the sampling intervals in the charge and discharge control.

FIG. 5 is a graph showing one example (Example 1) of the one-day trend of the power generated by the power generator.

FIG. 6 is a graph showing one example (Example 1) of the trends of the power output to the power grid when the power generator generates power as shown in FIG. 5 in the power generation system of the embodiment.

FIG. 7 is a graph showing one example (Example 1) of the trends of the power output to the power grid when the power generator generates power as shown in FIG. 5 in the power generation system of the comparative example.

FIG. 8 is a graph showing one example (Example 1) of the trends of the capacity of the battery cell when the power generator generates power as shown in FIG. 5 in the power generation system of the embodiment and the comparative example.

FIG. 9 is a graph showing one example (Example 2) of the one-day trend of the power generated by the power generator.

FIG. 10 is a graph showing one example (Example 2) of the trends of the power output to the power grid when the power generator generates power as shown in FIG. 9 in the power generation system of the embodiment.

FIG. 11 is a graph showing one example (Example 2) of the trends of the power output to the power grid when the power generator generates power as shown in FIG. 9 in the power generation system of the comparative example.

FIG. 12 is a graph showing one example (Example 2) of the trends of the capacity of the battery cell when the power generator generates power as shown in FIG. 9 in the power generation system of the embodiment and the comparative example.

FIG. 13 is a block diagram showing the configuration of the power generation system of the second embodiment of the invention.

FIG. 14 is a flow chart in order to explain the flow of the control of the charge and discharge control of the power generation system in the second embodiment shown in FIG. 13.

### BEST MODE OF EMBODYING THE INVENTION

Hereafter the embodiments of the present invention are explained based on the figures.

### First Embodiment

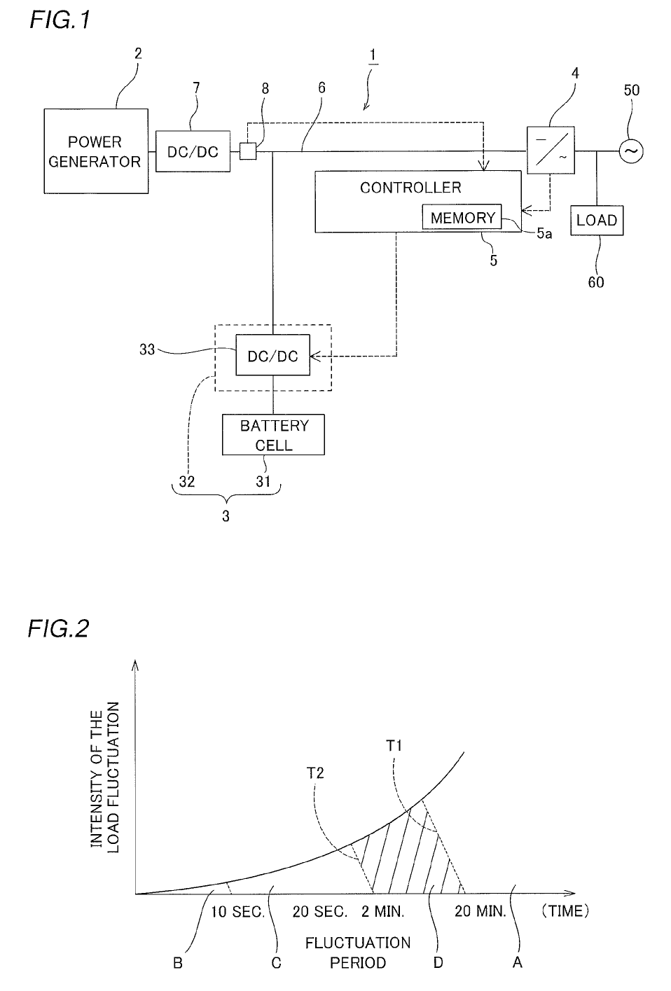

Firstly, the configuration of the power generation system of the first embodiment of the invention (Sunlight power generation system 1) is explained while referring to FIG. 1 and FIG. 2. Now, this embodiment is an example to explain the adaptation of the “charge and discharge system” in the present invention to the charge and discharge system of the sunlight power generation system 1 provided with a power generator comprised of a solar cell.

The sunlight power generation system 1 provides a power generator 2 comprised of a solar cell which generates power using the light of the sun, and a battery 3 capable of the storage of the electrical power generated by means of the power generator 2, and an electrical power output unit 4, connected to the power grid 50, including an inverter outputting the electrical power generated by means of the power generator 2 and the electrical power stored by means of the battery 3, and a controller 5 controlling the electrical charge and discharge of the battery 3. Moreover, load 60 is connected to the alternating current side of a bus connected to the power grid 50 and the power output unit 4.

There is a DC-DC converter 7 connected in series with the bus 6 to which the power generator 2 and the power output unit 4 are connected. The DC-DC converter 7 has the function of converting the DC voltage of the electrical power generated by means of the power generator 2 to a fixed DC voltage (approximately 260 V in the first embodiment) and the output thereof to the power output unit 4. Moreover, the DC-DC converter 7 has the so-called maximum power point tracking (MPPT) control functions. The MPPT function is the function of the automatic adjustment of the operational voltage of the power generator 2 so as to maximize the electrical power generated by means of the power generator 2. A diode (not shown in the figures) is provided between the power generator 2 and the DC-DC converter 7 so as to prevent the reverse flow of the electrical current from flowing towards the power generator 2.

The battery 3 includes the battery cell 31, and the charge and discharge unit 32 in order to charge and discharge the battery cell 31 which are connected in parallel to the bus 6. Secondary battery cells (for example, a lithium ion battery cell, or a Ni-MH battery cell, or the like) which have little natural discharge and high electrical charge/discharge efficiency may be employed as the battery cell 31. The voltage of the battery cell 31 is approximately 48 V.

The charge and discharge unit 32 has the DC-DC converter 33. The direct current side of bus 6 and the battery cell 31 are connected via DC-DC converter 33. The DC-DC converter 33 is used on the occasion of the electrical charging of the battery cell 31 to supply power from the direct current side of bus 6 to the battery cell 31 by lowering the voltage of the power supplied to the battery cell 31 from the voltage of the DC side of bus 6 to a voltage suited to charging the battery cell 31. On the occasion of the electrical discharging, the DC-DC converter 33 discharges electrical power from the battery cell 31 side to the DC side of bus 6 by raising the voltage of the electrical power supplied to the DC side of bus 6 from the voltage from the voltage of battery cell 31 to the vicinity of the voltage of the voltage of the DC side of bus 6.

The controller 5 performs the charge and discharge control of battery cell 31 by controlling the DC-DC converter 33. Specifically, the controller 5 performs the charge and discharge control of battery cell 31 in a manner such as to compensate for the difference between the power output by the power generator 2 and the target output value, based on the power output by the power generator 2 (The output electrical power of the DC-DC converter 7), and the later-described target output value. In other words, in the event that the power output by the power generator 2 is greater than the target output value, the controller 5 controls the DC-DC converter 33 to charge the battery cell 31 with the excess electrical power. On the other hand, in the event that the power output by the power generator 2 is less than the target output value, the controller 5 controls the DC-DC converter 33 to discharge the battery cell 31 to make up for the shortfall in the electrical power.

The detection unit 8 which detects the power output by the power generator 2 is provided on the output side of the DC-DC converter 7. The controller 5 can acquire power output data for each specific detection time interval (e.g. not more than 30 seconds), based on the output results of the detection unit 8 output. In the first embodiment, the controller 5 acquires the power output data by the power generator 2 every 30 seconds. If this detection time interval of the amount of the electricity is too long or too short due to inaccurate detection of the fluctuation in the power output, an appropriate value in consideration of the period of the fluctuation of the amount of the power output by the generator 2 is needed. In the first embodiment, the detection time interval is set to be shorter than the fluctuation period which can be responded by the load frequency control (LFC).

The controller 5, recognizes the difference between the actual power output by the power output unit 4 to the power grid 50, and the target output value by acquiring the output power of the electrical power output unit 4. By this means, the controller 5 enables feedback control on the electrical charging and discharging by the charge and discharge unit 32 such that the power output from the power output unit 4 becomes that of the target output value.

The controller 5 is configured to compute the target output value to the power grid using the moving average method. The moving average method is a computation method for the average value of the power output by the power generator 2 at a specific point in time based on the average of a period prior to that point in time. The prior power output data is successively recorded in memory 5a. Hereafter, the periods in order to acquire the power output data used in the computing the target output value are called the sampling intervals. The sampling intervals are between the fluctuation periods T1˜T2 corresponding to the load frequency control (LFC), in particular, preferably are of a range which are not very long periods greater than the vicinity of the latter half from T1 (in the vicinity of long periods). As a specific example of the value for the sampling interval, for example, they are intervals of not less than 10 minutes and less than 30 minutes in respect of the power grid having the characteristics of the “intensity of load fluctuation period” shown in FIG. 2, and in the first embodiment, the sampling interval is set at approximately 20 minutes. In this situation, because the controller 5 acquires the power output data approximately every 30 seconds, the target output value is computed from the average value of 40 power output data samples in the last 20 minute interval. There will be a detailed explanation provided below in respect of the upper limit period T1 and the lower limit period T2.

As described above, the sunlight power generation system 1 does not output the power output of the power generator 2 as is to the power grid 50, but computes the target output value from the power output by the power generator 2 in the past, and controls the charge and discharge of the battery cell 31 such that the total of the power output by the power generator 2, and the amount of the electrical charge and discharge of the battery cell 31 equals the target output value, and performs the charge and discharge control to output the target output value to the power grid 50. By performing this type of charge and discharge control, because the fluctuations in the power output to the power grid 50 are suppressed, the adverse impact on the power grid 50 of fluctuations in the power output by the power generator 2 are suppressed.

The controller 5 is not configured to perform charge and discharge control all the time, but to only exert the charge and discharge control when specific conditions are satisfied. In other words, the controller 5 does not exert the charge and discharge control when the adverse effects on the power grid 50 of the output of the power output by the power generator 2 are small, and is configured to only exert the charge and discharge control when the adverse effects would be great. Specifically, it is configured to perform the charge and discharge control when the amount of fluctuation in the power output by the power generator 2 is not less than a specific amount of fluctuation (hereafter referred to as “control initiating fluctuation amount”). The control initiating fluctuation amount may be an amount of fluctuation which is greater than the maximum amount of fluctuation for each detection time interval in the time period around noon on fine weather (a sunny day with almost no clouds), and as a specific number, for example, 5% of the rated power output of power generator 2. The amount of fluctuation in the power output is acquired by computing the difference in two sequential power output data samples by the power generator 2 as detected in the specific detection time intervals. Now, in relation to the specific number described above (5% of the rated power output of power generator 2), it is a numerical value which corresponds to the approximately 30 second detection time interval for the power output in the first embodiment, and in the event that the detection time interval is modified, the control initiating fluctuation amount would need to be set in accordance with that detection time interval.

After the initiation of charge and discharge control, the charge and discharge control is terminated when the controller 5 determines that the state of the variation in the power output has been below a certain specific standard in continuity for a specific period (Hereafter referred to as the ‘control termination determination period’).

As the index as to whether the fluctuation in the power generated is smaller than a specific standard, the difference between the target output value, and the detected power output at the point in time when the target output value was output, is utilized. The control termination determination period is a period corresponding to where the load frequency control can deal with the fluctuation period, and in the first embodiment, the upper limit period T1 is set at 20 minutes. As the specific standard, the value of 3% of the rated power output of the power generator 2 is used.

In other words, when the controller 5 is performing charge and discharge control, it is configured to terminate the charge and discharge control when a state continues for more than 20 minutes where the difference between the target output value and the detected power output at the point where the target output value was output was less than 3% of the rated power output of the power generator 2. The computation of the target output value and the detection of the generated power output are performed at a detection time interval (30 seconds), and the determination of whether the difference between the target output value and the generated power output is less than 3% of the rated power output of the power generator 2 is also performed for every detection time interval (30 seconds). Therefore, in the event that the size of difference between the target output value and the generated power output at each detection time interval was less than 3% of the rated power output on 40 consecutive occasions (a control termination determination period of 20 minutes), then the charge and discharge control are terminated. Now the control termination determination period is an example of the “first period” in the present invention.

Next, the main fluctuation controls performed in the fluctuation period range by means of the charge and discharge control of the first embodiment are explained. As shown in FIG. 2, the control methods to enable dealing with the fluctuation periods are different depending on the fluctuation period, and the fluctuation periods which can be dealt with by load frequency control are shown in domain D (The shaded domain). The domain A shows a fluctuation period where the load can be dealt with by means of the EDC. The domain B is a domain where the effects of the load fluctuation can be naturally absorbed by the endogenous control of the power grid 50. The domain C is a domain which can be dealt with by the governor free operation of the generators in each power generating location.

The border line between domain D and domain A corresponds to the upper limit period T1 of the fluctuation periods of the loads which can be dealt with by the load frequency control, while the border line between domain C and domain D corresponds to the lower limit period T2 of the fluctuation periods of the loads which can be dealt with by the load frequency control. This upper limit period T1 and the lower limit period T2, are not characteristic periods of FIG. 2, and can be understood to be numerical values fluctuating with the intensity of the load fluctuations. For example, the values of lower limit period 2 and the upper limit period T1 will vary depending on the so-called run-in effect in respect of the power grid side. The size of the run-in effect will also vary depending on the degree of installation of the solar power generation systems and their regional distribution.

In the first embodiment, in regard of the load fluctuation which the fluctuation periods (fluctuation frequencies) have and are included in the range of the domain D (a domain which LFC can deal with) but which governor free operation or endogenous control of the power grid 50 and EDC cannot deal with, the objective is to suppress the load fluctuation.

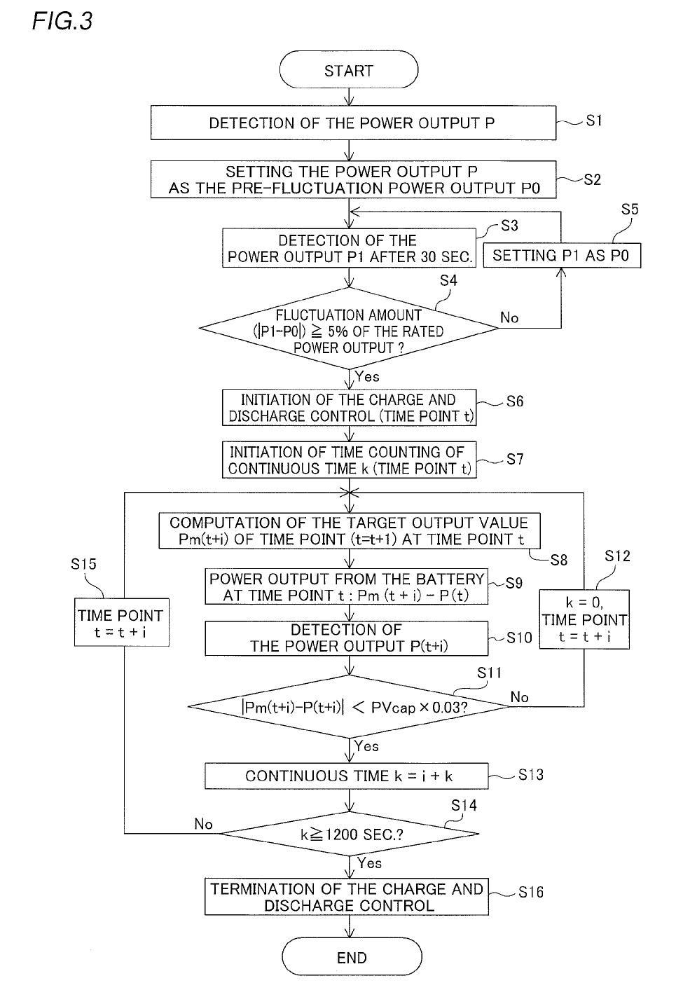

Next, an explanation is provided of the flow of control of the solar power generation system 1 by the first embodiment, while referring to FIG. 3.

Firstly, in Step S1, the controller 5 detects the power output P of the power generator 2 at a certain point in time. Then in Step S2, the controller 5 sets the detected power output P as the pre-fluctuation power output P0. Next, in Step S3, when 30 seconds (The detection time interval) has elapsed since the measurement of P0, the controller 5 again detects the power output and designates it as P1.

Thereafter in Step S4, the controller 5 makes a determination as to whether the fluctuation amount in the power generated (|P1−P0|) is not less than the control initiating fluctuation amount (5% of the rated power output of the power generator 2) or not.

If the fluctuation amount in the power generated is less than the control initiating fluctuation amount, the controller 5 sets P1 as P0 and acquires the value of P1 to monitor the fluctuation in the power generated in Step S3.

When the amount of fluctuation in the generated power output is not less than the control initiating fluctuation amount, in Step S6, the controller 5 initiates the charge and discharge control. In other words, with the mean value of the power output in the prior 20 minutes as the target output value, the controller 5 controls the charge and discharge of battery cell 31 so that the target output value is output by the power output unit 4. In the explanations hereafter, the starting point of the charge and discharge control are set as time point t.

In step S7, simultaneous with the initiation (time point t) of the charge and discharge control, the controller 5 initiates a count of the continuous time k of the continuity of a state where the difference between the target output value, and the detected power output at the output point of the target output value is less than 3% of the rated power output of the power generator 2.

In Step S8, the controller 5, computes at time t the power output (target output value Pm (t+i)) from power output unit 4 at time t+i (i: detection time interval of 30 seconds) by means of the moving average method.

Thereafter, in step S9, the controller 5 charge/discharges the difference in the power output between the target output value Pm (t+i) and the power output P (t), which is Pm (t+i)−P (t), from the battery cell 31. Now, when the Pm (t+i)−P (t) value is positive, the controller 5 charges the difference to the battery cell 31, and when negative, discharges the difference from the battery cell 31.

Then in Step S10, when the time is t+i, the controller 5 detects the power output P (t+i) at time t+i.

Moreover, in Step S11, at this time t+i, the controller 5 determines whether the difference in the absolute value between the target output value Pm (t+i) and the power output P (t+i) is less than 3% of the rated capacity PVcap of the battery cell 31 (whether |Pm(t+i)−P (t+i)|<PVcap×0.03 is satisfied or not).

In Step S12, when |Pm(t+i)−P (t+i)|<PVcap×0.03 is not satisfied, the controller 5 not only makes the continuous time k to be 0, and after making time t=t+i, returns to Step 8.

In Step S13, when |Pm(t+i)−P (t+i)|<PVcap×0.03 is satisfied, the controller 5 dose not make the continuous time k to be k+i.

Thereafter, in step S14, the controller 5 determines whether the continuous time k is not less than 1200 seconds (the control termination determination time of 20 minutes) or not.

Then in Step S15, when the continuous time k is less than 1200 seconds, the controller 5 after making t=t+i, returns to Step S8, and repeats the steps S8˜S15 until the continuous time k becomes not less than 1200 seconds.

Then in Step S16, when the continuous time k is not less than 1200 seconds, the controller 5 terminates the charge and discharge control.

Now even after the controller 5 terminates the charge and discharge control in Step S16, the Steps S1˜S5 are performed continuously during the operation of the solar power generator system 1. Then after the charge and discharge control is terminated, when the amount of fluctuation (|P1−P0|) in the power generated is not less than the control initiating fluctuation amount (5% of the rated power of the power generator 2) once more, the controller 5 proceeds to the steps from S6 onwards, and immediately restarts the charge and discharge control.

In the first embodiment, as described above, when a determination is reached by the controller 5 that the state, where the fluctuation in the power generated by the power generator 2 is less than a specific standard, has continued for longer than the control termination determination period, the charge and discharge control of the battery 3 is terminated. To put this another way, when the fluctuations in the power output of the power generator 2 are less than a specific standard, then the effects on the power grid 50 of output of the power output of the power generator 2 directly are small, the controller 5 can terminate the charge and discharge control. By this means, because the number of instances of charge and discharge control of the battery 3 can be reduced, a contrivance at lengthening the lifetime of the battery 3 is enable. Moreover, by making the continuity of the state, where the fluctuation in the power generated by the power generator 2 is less than a specific standard, a condition, the suppression of the termination of the charge and discharge control when the amount of fluctuation is reduced for a short interval, followed immediately by a return to state where the fluctuations are great, is enabled. By this means, while performing sufficient smoothing (The charge and discharge control), the power generated by the power generator 2 can be output to the power grid, as is, when the effects on the power grid 50 are small, and the controller 5 can terminate the charge and discharge control. Furthermore, in distinction to performing charge and discharge control all day long, because the charge and discharge control is not performed in a time slot where a state in which the fluctuation in the power generated by the power generator 2 is less than a specific standard (for example from the evening onwards) and has continued for longer than the control termination determination period, the charge and discharge control is not performed, and the amount of fluctuation in the charge and discharge state of the battery 3 can be reduced accordingly. By this means, because the depth of the charge and discharge of the battery 3 can be reduced, a contrivance at lengthening the lifetime of the battery is enabled.

Moreover, in the first embodiment, as described above, when a state, where the difference between the set target output value and the actual power output at the point of the output of the power generator 2 continues to be less than 3% of the rated power output, has continued for more than the control termination determination period, the controller 5 terminates the control of the battery 3. By enabling this type of configuration, and by setting the difference between the set target output value and the actual power output at the point of the output of the power generator 2 as the index, the determination of whether the state where the fluctuation in the power output of the power generator 2 is less than a specific standard for longer than the control termination determination period can be performed easily.

Furthermore, in the first embodiment, as described above, when a state, where the difference between the set target output value and the actual power output at the point of the output of the power generator 2 continues to be less than 3% of the rated power output, has not continued for more than the control termination determination period, the controller 5 continues the control of the battery 3. By means of this type of configuration, because suppression of the termination of the charge and discharge control in time bands where the states where the fluctuation is small cannot continue for very long, such as at midday, and so situations where a large difference between the charged capacity at the initiation of charge and discharge control and the charged capacity at the termination of charge and discharge control can be suppressed (Overcharging or over discharging).

Moreover, in the first embodiment, as described above, by performing the determination of when a state, where the difference between the set target output value and the actual power output at the point of the output of the power generator 2 continues to be less than 3% of the rated power output, has continued for more than the control termination determination period or not, at specific detection time intervals, the controller 5 can make a determination if the difference has continued for more than the control termination determination period or not. By means of this type of configuration, because the determination of whether a state, where the difference between the set target output value and the actual power output at the point of the output of the power generator 2 continues to be less than 3% of the rated power output, has continued for more than the control termination determination period is performed plural times within the control termination determination period, the controller 5 can more accurate perform the determination of whether a state, where the difference between the set target output value and the actual power output at the point of the output of the power generator 2 continues to be less than 3% of the rated power output, has continued for more than the control termination determination period or not.

Moreover, in the first embodiment, as described above, the controller 5 can set the limit of the period for the detection time interval to be lower than the lower limit period of where the load frequency control can deal with. By acquiring the power output at this kind of detection time interval, the controller 5 can easily detect fluctuations in the generated power output having fluctuation periods which the load frequency control can deal with. By this means, the controller 5 can perform charge and discharge control such as to reduce the fluctuation components of the fluctuation periods which the load frequency control can deal with.

Furthermore, in the first embodiment, as described above, the controller 5, by setting the sampling period to be lower than the lower limit period of where the load frequency control can deal with, the charge and discharge control enables the computed target output value to be in the range of this type of sampling period. By this means, in particular, the reduction in the fluctuation components of the fluctuation periods which the load frequency control can deal with is enabled, and the effective suppression of the effects on the power grid 50 in the range of the fluctuation periods which the load frequency control can deal with is enabled.

Moreover, in the first embodiment, as described above, the controller 5 by setting the time of the control termination determination period to correspond with the fluctuation period which the load frequency control can deal with, a determination to terminate the charge and discharge control is enabled when the fluctuations in the power output of the power generator 2 are smaller than a specific standard in continuity for longer than the control termination determination period. By this means, the charge and discharge control means can terminate the charge and discharge control when the fluctuation components of the fluctuation periods which the load frequency control can deal with are sufficiently fewer.

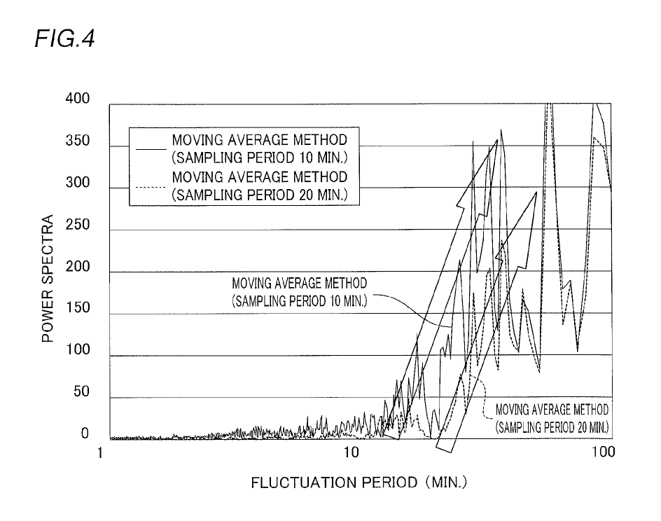

Next, the sampling period of the moving average method are considered. Here, the results of the FFT analysis of the power output data when the sampling period which is the acquisition period of the power output data was 10 minutes, and the results of the FFT analysis of the power output data when the sampling period was 20 minutes are shown in FIG. 4. It can be appreciated that when the sampling period was 10 minutes, while the fluctuations in respect of a range of less than 10 minutes of a fluctuation period could be suppressed, the fluctuations in a range of fluctuation periods which were not less than 10 minutes were not suppressed well. Moreover, when the sampling period was 20 minutes, while the fluctuations in respect of a range of less than 20 minutes of a fluctuation period could be suppressed, the fluctuations in a range of fluctuation periods which were not less than 20 minutes was not suppressed well. Therefore, it can be understood that there is a good mutual relationship between the size of the sampling period, and the fluctuation period which can be suppressed by the electrical charge and discharge control. For this reason, it can be said that by setting the sampling period, the range of the fluctuation period which can be controlled effectively changes. In that respect, in order to suppress parts of the fluctuation period which can be addressed by the load frequency control which is the main focus of this system, it can be appreciated that in order that sampling intervals which are greater than the variation period corresponding to what the load frequency control can deal be set, in particular, it is preferable that they be set from the vicinity of the latter half of T1˜T2 (The vicinity of longer periods) to periods with a range not less than T1. For example, in the example in FIG. 2, by utilizing a sampling period of greater than 20 minutes, it can be appreciated that suppression of most of the fluctuation periods corresponding to the load frequency control is enabled. However, when the sampling period is lengthened, there is a tendency for the required battery cell capacity to become greater, and it is preferable to select a sampling period which is not much longer than T1.

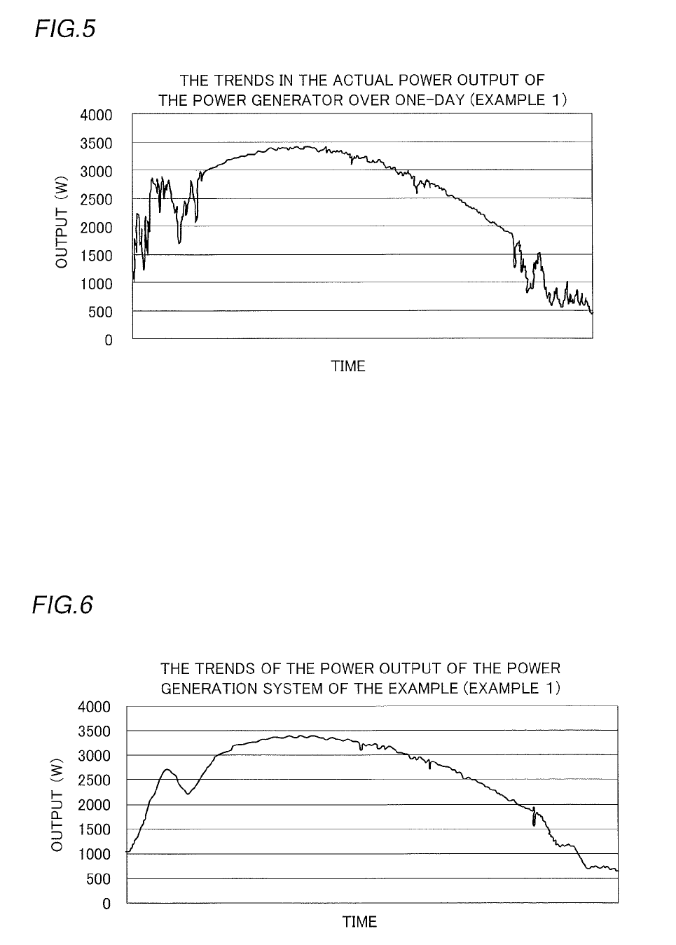

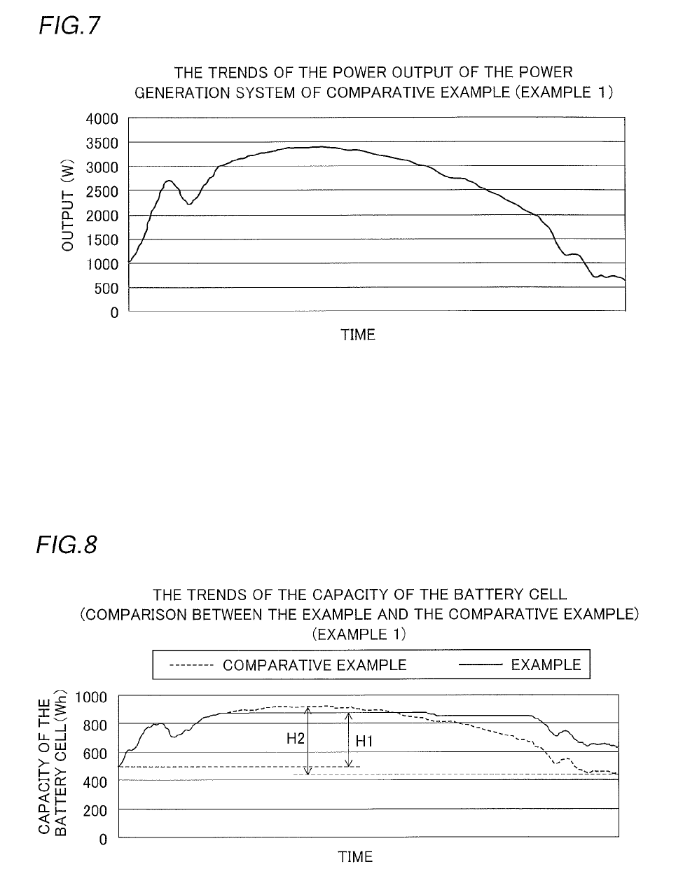

Next, the simulation results (Example 1) proving the effectiveness of the performance of the charge and discharge control of the present invention are explained while referring to FIG. 5˜FIG. 8. In FIG. 5, the trends in the power output over one-day of a power generator with a rated power output of 4 kW (Example 1) are shown. In FIG. 6, in the power generation system of the invention, the results of an example of a simulation are shown of the power output to the power grid when the generated power trend of the power generator is as shown in FIG. 5, and in FIG. 7 a comparative example of a power system, the results of a simulation are shown of the power output to the power grid when the generated power trend of the power generator is as shown in FIG. 5. Now in the example, the configuration of the initiation and the termination of the charge and discharge control was as described in the first embodiment above. Moreover, in FIG. 8 a comparison is shown of the trends of the battery cell capacity corresponding to the example of the power generation system of FIG. 6, and that of the power generation system of the comparative example shown in FIG. 7.

As shown in FIG. 5˜FIG. 7, in both the example and the comparative example, it can be appreciated that smoothing of the fluctuations in the power output of the power generator as shown in FIG. 5 was enabled. As shown in FIG. 6, while there was fluctuation in the power output of the power generator remaining when compared with the comparative example, that remaining fluctuation was mainly in the fluctuation period of not more than approximately two minutes (a fluctuation period which is less than the lower limit of the fluctuation periods which load frequency control can deal with), and is a fluctuation period which the governor free operation of the generators of generating stations can deal with. In other words, in the power generation system of the example, the output fluctuations were suppressed in the fluctuation periods which the load frequency control can deal with.

Moreover, as shown in FIG. 8, whereas the capacity of the battery cell in the power generation system by means of the comparative example fluctuated all the time, in the power system of the example, the capacity of the batter cell was greater for a fixed period. In other words, it can be appreciated that, in comparison with the comparative example, the number of charge and discharge times of the battery cell in the example was greatly reduced. This is because charge and discharge was not performed in the example in the periods when the fluctuations in the power output were stable (Time periods when the fluctuations were less than a standard amount). Moreover, in this simulation, while the total charged and discharged capacity during one day in the example was approximately 1122 Wh, in the comparison example the total of the charged and discharged capacity was approximately 1246 Wh. In other words, it can be appreciated that the charged and discharged capacity in the example was reduced when compared to the comparative example. Furthermore, as shown in FIG. 8, it can be appreciated that the degree of charge and discharge depth H1 of the battery cell in the example was less than the degree of charge and discharge depth H2 of the battery cell in the comparative example.

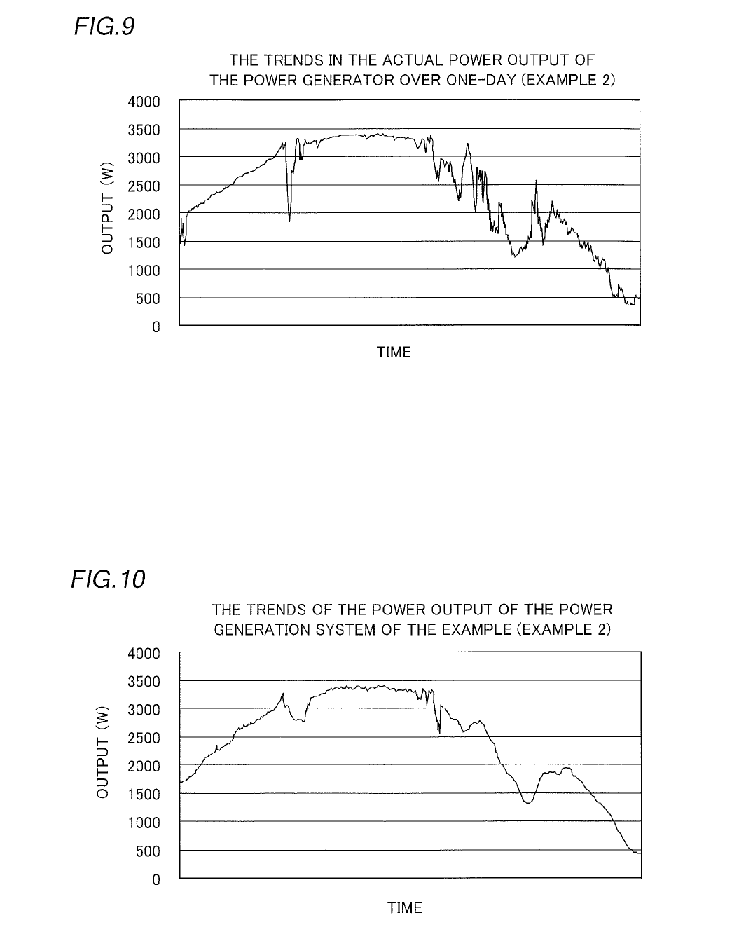

Next, the simulation results (Example 2) proving the effectiveness of the performance of the charge and discharge control of the present invention are explained while referring to FIG. 9˜FIG. 12. In FIG. 9˜FIG. 12 the same simulation results as shown in FIG. 5˜FIG. 8 are shown for a different example from Example 1.

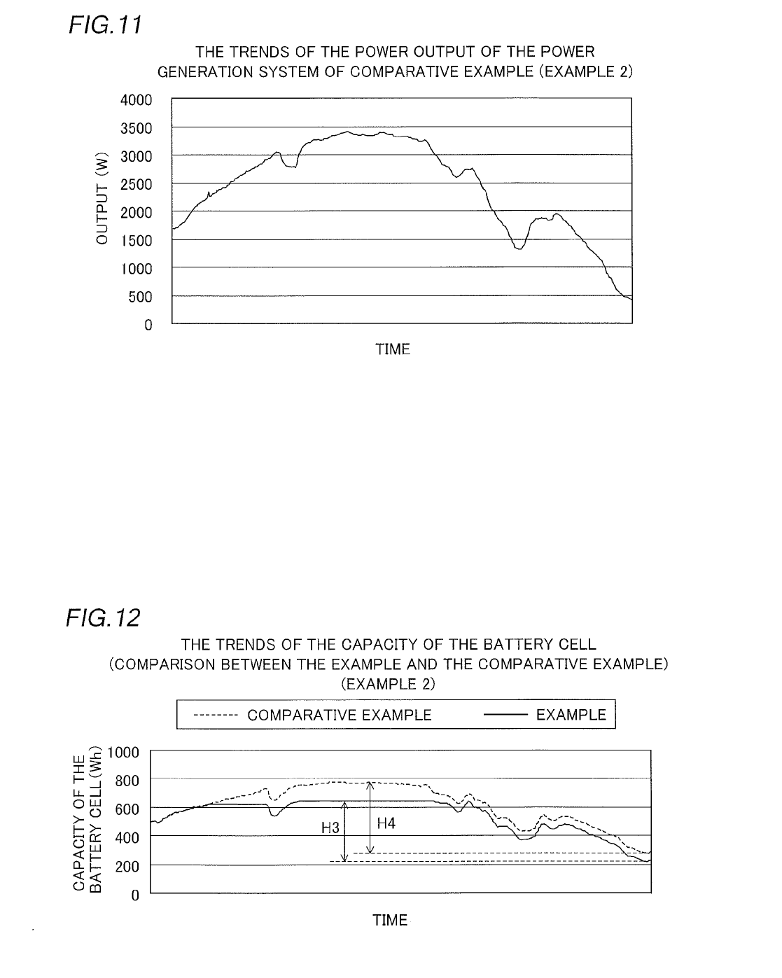

As shown in FIG. 9˜FIG. 11, in both the example and the comparative example, it can be appreciated that smoothing of the fluctuations in the power output of the power generator was enabled. Moreover, as shown in FIG. 12, in example just as was the case for example 1, it can be appreciated that, in comparison with the comparative example, the number of charge and discharge times of the battery cell in the example was greatly reduced. Furthermore, in this simulation, while the total charged and discharged capacity during one day in example 2 was approximately 1222 Wh, in the comparison example the total of the charged and discharged capacity was approximately 1451 Wh. In other words, it can be appreciated that even in example 2, the charged and discharged capacity in the example was reduced when compared to the comparative example. Furthermore, as shown in FIG. 12, it can be appreciated that the degree of charge and discharge depth H3 of the battery cell in the example was less than the degree of charge and discharge depth H4 of the battery cell in the comparative example.

### Second Embodiment

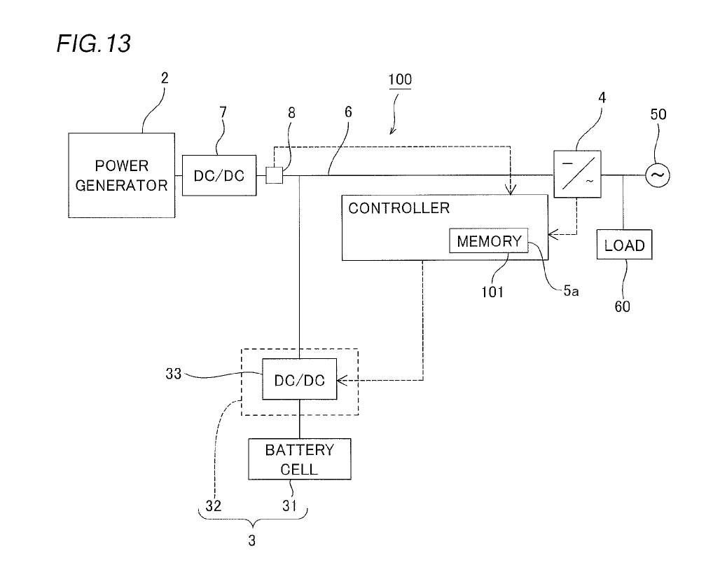

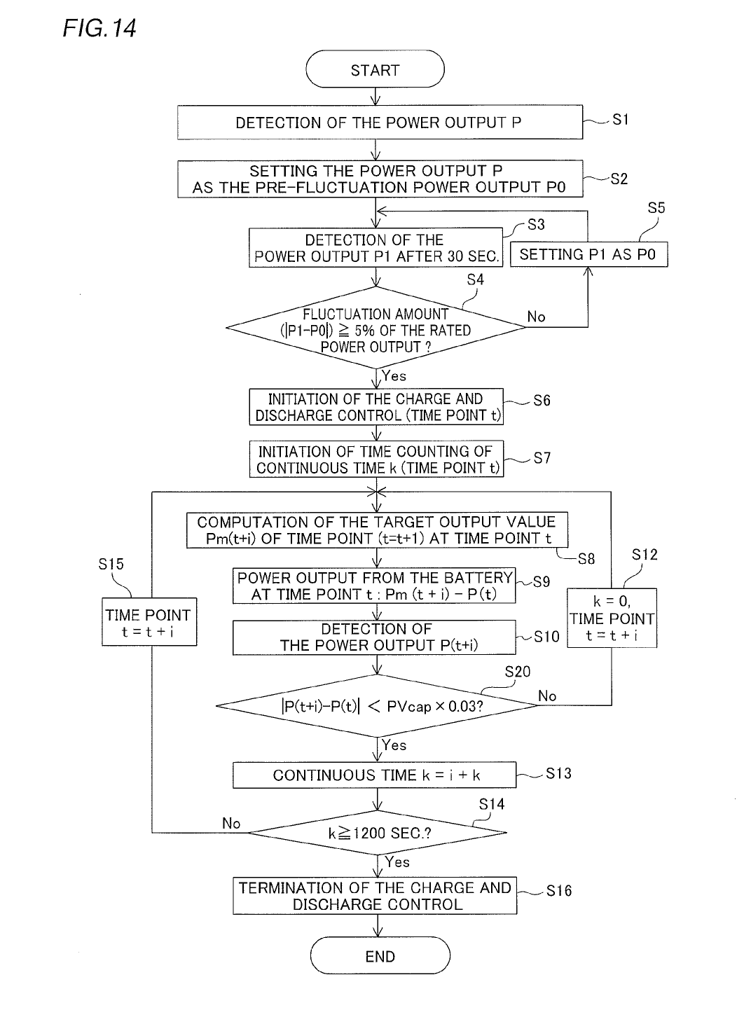

Next, the solar power generation system of the second embodiment of the present invention is explained while referring to FIG. 13 and FIG. 14. In the first embodiment, the difference between the target output value and the actual power output based on the target output value at the actual point of output was used as the index to determine whether the fluctuation in the power generated by the power generator 2 is less than a specific standard or not. On the other hand, in the second embodiment, an explanation is provided of fluctuation in the power output is used as the index.

The solar power generation system 100 of the second embodiment has a controller 101 provided instead of the controller 5 of the first embodiment. The configuration other than the controller 101, is the same as in the solar power generation system 1 if the first embodiment described above.

After the initiation of the charge and discharge control, the charge and discharge control is terminated when the controller 101 determines that the state of the fluctuation in the power output has been below a certain specific standard in continuity for a specific period. On the other hand, the charge and discharge control is not terminated when the controller 101 determines that the state of the fluctuation in the power output has not been below a certain specific standard in continuity for a specific period, and the controller 101 is configured to continue the charge and discharge control until such continuity is established.

In the second embodiment, the amount of fluctuation in the power output is used as the index to determine whether the fluctuation in the power output is less than a specific standard or not. Moreover as the specific standard, the value of 3% of the rated power output of the power generator 2 is used. In other words, when the controller 101 is performing charge and discharge control, it is configured to terminate the charge and discharge control when a state continues for more than 20 minutes where the amount of fluctuation in the power output is less than 3% of the rated power output of the power generator 2. In respect of the controls other than the termination of the charge and discharge control, they are the same as described in the first embodiment above.

Next, an explanation is provided of the flow of control of the solar power generation system 100 by the second embodiment, while referring to FIG. 14.

In the second embodiment, in respect of Steps S1˜S10, charge and discharge control is initiated in the same manner as in the first embodiment above, and the charge and discharge of battery cell 31 is performed. Then, in Step S20, at this time t+i, a determination is made as to whether the fluctuation amount in the power output (the difference in the absolute value between the power output P (t+i) and the power output P (t)) is less than 3% of the rated capacity PVcap of the battery cell 31 (whether |P (t+i)−P (t)|<PVcap×0.03 is satisfied or not).

When |P(t+i)−P(t)|<PVcap×0.03 is not satisfied, the continuous time k is set to 0, and after making time t=t+i, returns to Step 8. Moreover, when |P(t+i)−P(t)|<PVcap×0.03 is satisfied, in Step S13 the continuous time k is set to be k+i. Thereafter, in step S14, a determination is made as to whether the continuous time k is not less than 1200 seconds (the control termination determination time of 20 minutes) or not. When the continuous time k is less than 1200 seconds, in step S15, after setting t to t=t+i, the system returns to Step S8, and repeats the steps S8˜S10, and step S20 and steps S12˜S15 until the continuous time k becomes not less than 1200 seconds. Then in Step S16, when the continuous time k is not less than 1200 seconds, the charge and discharge control is terminated.

The benefits of the second embodiment are the same as those described for the first embodiment described above.

Now the embodiments and examples disclosed here should be considered for the purposes of illustration in respect of all of their points and not limiting embodiments. The scope of the present invention is represented by the scope of the patent claims and not the embodiments described above, in addition to including all other modifications which have an equivalent meaning and fall within the scope of the patent claims.

For example, in the first and second embodiments described above, embodiments where solar cells were employed as the power generator 2, but this invention is not limited to this, and other renewable energy power output devices such as wind power devices may be employed.

Moreover, in the first and second embodiments described above, embodiments were represented where lithium ion batteries or Ni-MH batteries were employed as the storage cell, but this invention is not limited to these, and may employ other secondary batteries.

Moreover, in the first and second embodiments described above, an explanation was provided of embodiments where the voltage of the battery cell 31 was 48V, but this invention is not limited to this, and voltages other than 48 V may be employed. Now the voltage of the battery cell is preferably not more than 60V.

Furthermore, in the first and second embodiments described above, embodiments were described wherein the control initiating fluctuation amount was set at 5% of the rate power output of the power generator 2, but this invention is not limited to these, and the control initiating fluctuation amount can be set at standard of the pre-fluctuation amount.

Furthermore, in the first and second embodiments described above, an explanation was provided whereby the power consumption in the consumer home was not taken into consideration in the load in the consumer home, but this invention is not limited to this, and in the computation of the target output value, a power is detected wherein at least part of the load is consumed at the consumer location, and the computation of the target output value may be performed considering that load consumed power output or the fluctuation in the load consumed power output.

Moreover, in the sampling intervals described in the first and second embodiments, in regard to the specific values of the bus voltages and the like, they are not limited to these in this invention, and may be modified appropriately.

Furthermore, in the first and second embodiments described above, an explanation was provided wherein the generated power output difference was detected by obtaining the difference of the power output detected by the detection unit 8, but this invention is not limited to this, and the detection of a power which reflects the generated power output may be used.

Moreover, in the first embodiment described above, an example was described where the difference between the target output value and the actual power output based on the target output value at the actual point of output was used as the index, but the present invention is not limited to this, and the difference between the target output value and the actual power output based on the target output value at one earlier detection point interval (30 seconds) earlier (or later) can be used as the index.

Furthermore, In the first and second embodiments described above, an explanation was provided wherein the control terminating determination period be set to correspond to the fluctuation periods which the LFC can deal with (not less than the lower limit period T2, and not more than the upper limit period T1), but the invention is not limited to this, and may be enable for more than the upper limit period T1, and for less than the lower limit period T2.

Moreover, in the first and second embodiments described above, an explanation was provided of embodiments wherein the standard for the determination of whether the fluctuations in the power generated was 3% of the rated power output, the present invention is not limited to this, and may employ another value.

Furthermore, in the first and second embodiments described above, an explanation was provided of a configuration wherein the controller 5 controls the DC-DC converter 33 in order to perform the charge and discharge control of the battery cell 31, but the present invention is not limited to this. For example, by the provision of a charge and discharge switch for the charge and discharge unit 32 to perform the charge and discharge control of the battery cell 31, and the control of the charge and discharge of battery cell 31 may be configured by the controller 5 performing the control of the ON/OFF of the charge and discharge switch.

1. An electrical charge and discharge system, comprising:
a battery configured to store electric power generated by a power generator using renewable energy;
a power output device configured to output power generated by the power generator and power discharged by the battery; and
a controller configured to control charge and discharge of the battery and to terminate the charge and discharge control of the battery when determined that a fluctuation in power generated by the power generator is less than a standard in continuity for not less than a first period.

2. The system of claim 1, wherein the controller is further configured to determine whether the fluctuation in the power generated by the power generator is less than the standard based on either a difference between target output value to be outputted from the power output device and the power generated by the power generator or fluctuation in the power generated by the power generator.

3. The system of claim 2, wherein the controller is further configured to terminate the charge and discharge control of the battery when the difference between the generated power of the power generator and the target output value for the power output device continues to be less than the standard for not less than the first period.

4. The system of claim 3, wherein the controller is further configured to acquire power data that is an amount of electric power generated by the power generator, to compute the target output value based on the power data, and to determine the difference between the generated power of the power generator and the target output value for the power output device that are determined at a vicinity of a time of outputting the target output value for the power output device.

5. The system of claim 4, wherein the controller is further configured to continue the charge and discharge control of the battery when the difference does not continue to be less than the standard for not less than the first period.

6. The system of claim 4, wherein the controller is further configured to acquire the power data at specific detection time intervals, to compute the target output value at each of the specific detection time intervals, to determine whether the difference is less than the standard at each of the specific detection time intervals, and to determine whether the difference continues to be less than the standard for not less than the first period.

7. The system of claim 4, wherein the controller is further configured to acquire the power data at a specific detection time intervals, and to compute the target output value at each of the specific time intervals,
wherein the power data that are acquired at the vicinity of the time of outputting the target output value for the power output device comprise power data acquired at a detection time corresponding to the outputting of the target output value and a detection time prior or subsequent to the time corresponding to the outputting of the target output value.

8. The system of claim 2, wherein the controller is further configured to acquire fluctuation data that is the fluctuation in the power generated by the power generator, to determine whether the fluctuation is less than the standard based on the fluctuation data, and to terminate the charge and discharge control of the battery when the fluctuation continues to be less than the standard for not less than the first period.

9. The system of claim 8, wherein the controller is further configured to acquire power data that is an amount of electric power generated by the power generator at specific detection time intervals, and to compute the fluctuation data based on the difference of the power data acquired at two consecutive times of the detection time intervals.

10. The system of claim 1, wherein the controller is further configured to acquire fluctuation data that is an fluctuation in the power generated by the power generator, to restart the charge and discharge control of the battery, after terminating the charge and discharge control of the battery, when the fluctuation data exceed a specific control initiating fluctuation amount.

11. An electrical charge and discharge device controlling a battery storing electric power generated by a power generator generating electric power using renewable energy, comprising:
a controller configured to terminate charge and discharge control of the battery when determined that a fluctuation in power generated by the power generator is less than a standard in continuity for not less than a first period.

12. A device of claim 11, wherein the controller is further configured to determine whether the fluctuation in the power generated by the power generator is less than the standard based on either a difference between target output value to be outputted from the power output device and the power generated by the power generator or fluctuation in the power generated by the power generator.

13. A device of claim 11, wherein the controller is further configured to acquire fluctuation data that is the fluctuation in the power generated by the power generator, to determine whether the fluctuation is less than the standard based on the fluctuation data, and to terminate the charge and discharge control of the battery when the fluctuation continues to be less than the standard for not less than the first period.

14. A method of controlling electrical charge and discharge of a battery storing electric power generated by a power generator generating electric power using renewable energy, comprising:
determining a fluctuation in power generated by the power generator; and
terminating a charge and discharge control of the battery when determined that a fluctuation in power generated by the power generator is less than a standard in continuity for not less than a first period.

15. The method of claim 14, wherein the charge and discharge control of the battery is terminated when a difference between the power generated by the power generator and target output value to be outputted from the battery and the power generator is less than the standard for not less than the first period.

16. The method of claim 14, wherein the charge and discharge control of the battery is terminated when a fluctuation in the power output of the power generator is less than the standard not less than the first period.

17. A computer-readable recording medium which records a control programs for causing one or more computers to perform the steps comprising:
determining a fluctuation in power generated by a power generator; and
terminating a charge and discharge control of the battery when determined that a fluctuation in power generated by the power generator is less than a standard in continuity for not less than a first period.

18. The computer-readable recording medium of claim 17, wherein in the termination step the charge and discharge control of the battery is terminated when a difference between the power generated by the power generator and target output value to be outputted from the battery and the power generator is less than the standard for not less than the first period.

19. The computer-readable recording medium of claim 17, wherein in the termination step the charge and discharge control of the battery is terminated when a fluctuation in the power output of the power generator is less than the standard not less than the first period.
